(19) United States
(12) Patent Application Publication
(10) Pub. No.: US 2014/0330902 A1
(43) Pub. Date: Nov. 6, 2014

(54) MULTI-STATUS CONTROL SYSTEM AND METHOD

(71) Applicant: Google Inc., (US)

(72) Inventor: Xiaoyan Zhao, Sunnyvale, CA (US)

(73) Assignee: Google Inc., Mountain View, CA (US)

(21) Appl. No.: 13/887,715

(22) Filed: May 6, 2013

(51) Int. Cl. H04L 29/08

(52) U.S. Cl. CPC H04L 67/306
USPC 709/204

(57) ABSTRACT

A method, computer program product, and computing system for defining a plurality of groups for a user of an electronic communication platform, wherein at least one member of the electronic communication platform belongs to each of the plurality of groups. A first user status for the user of the electronic communication platform may be identified. The first user status may be associated with a first group of the plurality of groups. A second user status may be identified for the user of the electronic communication platform. The second user status may be associated with a second group chosen from the plurality of groups.

### TECHNICAL FIELD

This disclosure relates to status indication systems and, more particularly, to status indication systems within an electronic communication platform.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public website in which they may post entries that are published for multiple people to read. Examples of such websites may include but are not limited to product/service review sites and topical blogs.

One such use of the Internet is to allow people to communicate via one or more electronic communication platforms, examples of which may include but are not limited to social networks, messaging applications, chat platforms, and email systems. Such platforms may be configured to provide other users of the electronic communication platform with a status indicator with respect to your availability to engage in chat (e.g., instant message) session. Unfortunately, such platforms may provide e.g., an available status indicator to a person or a group of people that you are not currently interested in/available for chatting with. For example, while on vacation, a user may not wish to chat with coworkers and, conversely, during work hours, a user may not wish to chat with family/friends.

### SUMMARY OF DISCLOSURE

In one implementation, a computer-implemented method includes defining a plurality of groups for a user of an electronic communication platform, wherein at least one member of the electronic communication platform belongs to each of the plurality of groups. A first user status for the user of the electronic communication platform may be identified. The first user status may be associated with a first group of the plurality of groups. A second user status may be identified for the user of the electronic communication platform. The second user status may be associated with a second group chosen from the plurality of groups.

One or more of the following features may be included. The first user status may be different from the second user status. The plurality of groups may include one or more of: a coworkers group, a family group, and a friends group.

Associating the first user status with the first group may include associating the first user status with the first group chosen from the plurality of groups for a defined time interval. The defined time interval may be chosen from the group consisting of: a defined quantity of time, and a defined window of time.

Associating the second user status with the second group may include associating the second user status with the second group chosen from the plurality of groups for a defined time interval. The defined time interval may be chosen from the group consisting of: a defined quantity of time, and a defined window of time. The first group may be chosen from the plurality of groups.

In another implementation, a computer program product resides on a computer readable medium and has a plurality of instructions stored on it. When executed by a processor, the instructions cause the processor to perform operations including defining a plurality of groups for a user of an electronic communication platform, wherein at least one member of the electronic communication platform belongs to each of the plurality of groups. A first user status for the user of the electronic communication platform may be identified. The first user status may be associated with a first group of the plurality of groups. A second user status may be identified for the user of the electronic communication platform. The second user status may be associated with a second group chosen from the plurality of groups.

One or more of the following features may be included. The first user status may be different from the second user status. The plurality of groups may include one or more of: a coworkers group, a family group, and a friends group.

Associating the first user status with the first group may include associating the first user status with the first group chosen from the plurality of groups for a defined time interval. The defined time interval may be chosen from the group consisting of: a defined quantity of time, and a defined window of time.

Associating the second user status with the second group may include associating the second user status with the second group chosen from the plurality of groups for a defined time interval. The defined time interval may be chosen from the group consisting of: a defined quantity of time, and a defined window of time. The first group may be chosen from the plurality of groups.

In another implementation, a computing system including a processor and memory is configured to perform operations including defining a plurality of groups for a user of an electronic communication platform, wherein at least one member of the electronic communication platform belongs to each of the plurality of groups. A first user status for the user of the electronic communication platform may be identified. The first user status may be associated with a first group of the plurality of groups. A second user status may be identified for the user of the electronic communication platform. The second user status may be associated with a second group chosen from the plurality of groups.

One or more of the following features may be included. The first user status may be different from the second user status. The plurality of groups may include one or more of: a coworkers group, a family group, and a friends group.

Associating the first user status with the first group may include associating the first user status with the first group chosen from the plurality of groups for a defined time interval. The defined time interval may be chosen from the group consisting of: a defined quantity of time, and a defined window of time.

Associating the second user status with the second group may include associating the second user status with the second group chosen from the plurality of groups for a defined time interval. The defined time interval may be chosen from the group consisting of: a defined quantity of time, and a defined window of time. The first group may be chosen from the plurality of groups.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a multi-status control process according to an implementation of the present disclosure;

FIG. 2 is a flowchart of the multi-status control process of FIG. 1 according to an implementation of the present disclosure; and

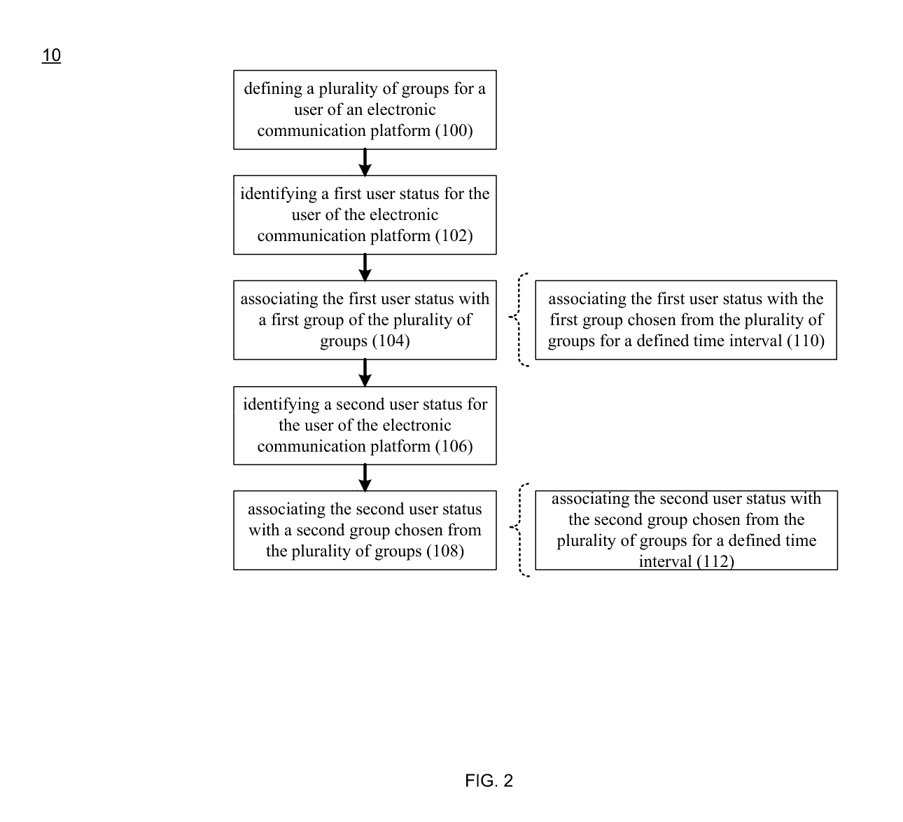

FIG. 3 is a diagrammatic view of a graphical user interface rendered by the multi-status control process of FIG. 1 according to an implementation of the present disclosure.

Like reference symbols in the various drawings indicate like elements.

### DETAILED DESCRIPTION OF THE PREFERRED EMBODIMENTS

System Overview

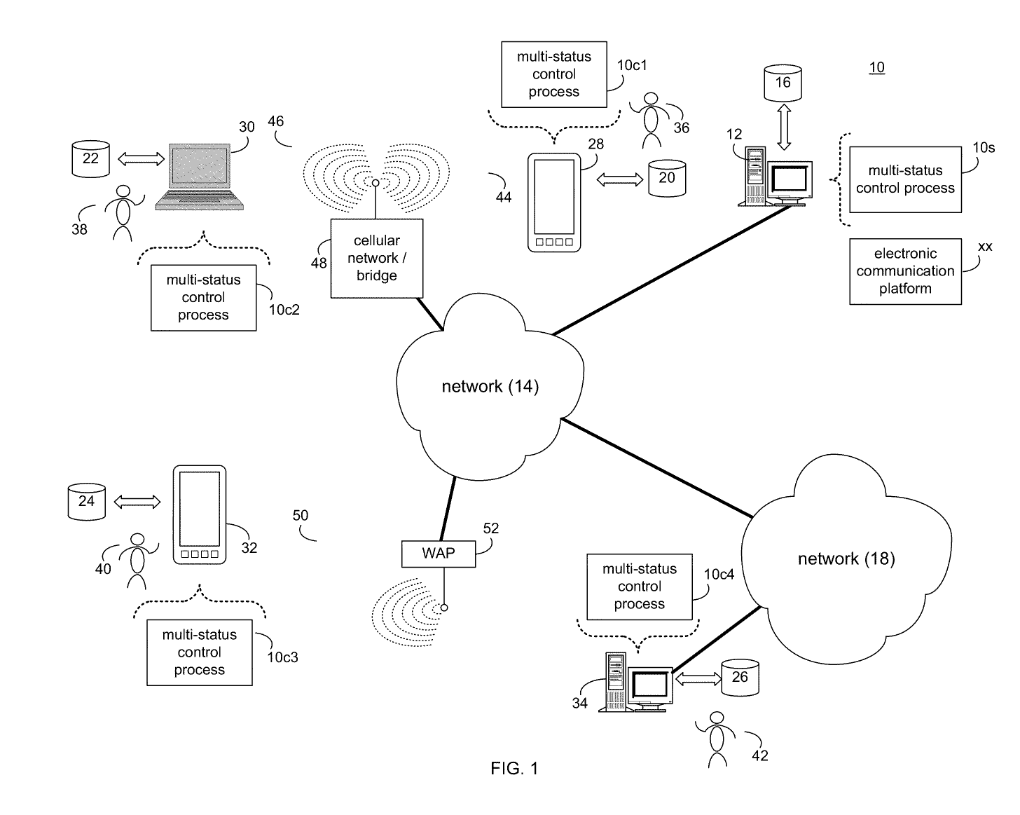

In FIGS. 1 & 2, there is shown multi-status control process 10. Multi-status control process 10 may be implemented as a server-side process, a client-side process, or a hybrid server-side/client-side process. For example, multi-status control process 10 may be implemented as a purely server-side process via multi-status control process 10s. Alternatively, multi-status control process 10 may be implemented as a purely client-side process via one or more of multi-status control process 10c1, multi-status control process 10c2, multi-status control process 10c3, and multi-status control process 10c4. Alternatively still, multi-status control process 10 may be implemented as a hybrid server-side/client-side process via multi-status control process 10s in combination with one or more of multi-status control process 10c1, multi-status control process 10c2, multi-status control process 10c3, and multi-status control process 10c4. Accordingly, multi-status control process 10 as used in this disclosure may include any combination of multi-status control process 10s, multi-status control process 10c1, multi-status control process 10c2, multi-status control process 10c3, and multi-status control process 10c4.

As will be discussed below in greater detail, multi-status control process 10 may define 100 a plurality of groups for a user of an electronic communication platform. At least one member of the electronic communication platform may belong to each of the plurality of groups. A first user status may be identified 102 for the user of the electronic communication platform; and this first user status may be associated 104 with a first group of the plurality of groups. A second user status may be identified 106 for the user of the electronic communication platform; and the second user status may be associated 108 with a second group chosen from the plurality of groups.

Multi-status control process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of multi-status control process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of multi-status control processes 10c1, 10c2, 10c3, 10c4 may include but are not limited to a web browser, a web browser plug-in or applet, a game console user interface, a video conference user interface, or a specialized application (e.g., an application running on e.g., the Android™ platform or the iOS™ platform). The instruction sets and subroutines of multi-status control processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a television (not shown), a tablet computer (not shown) and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

Multi-Status Control Process

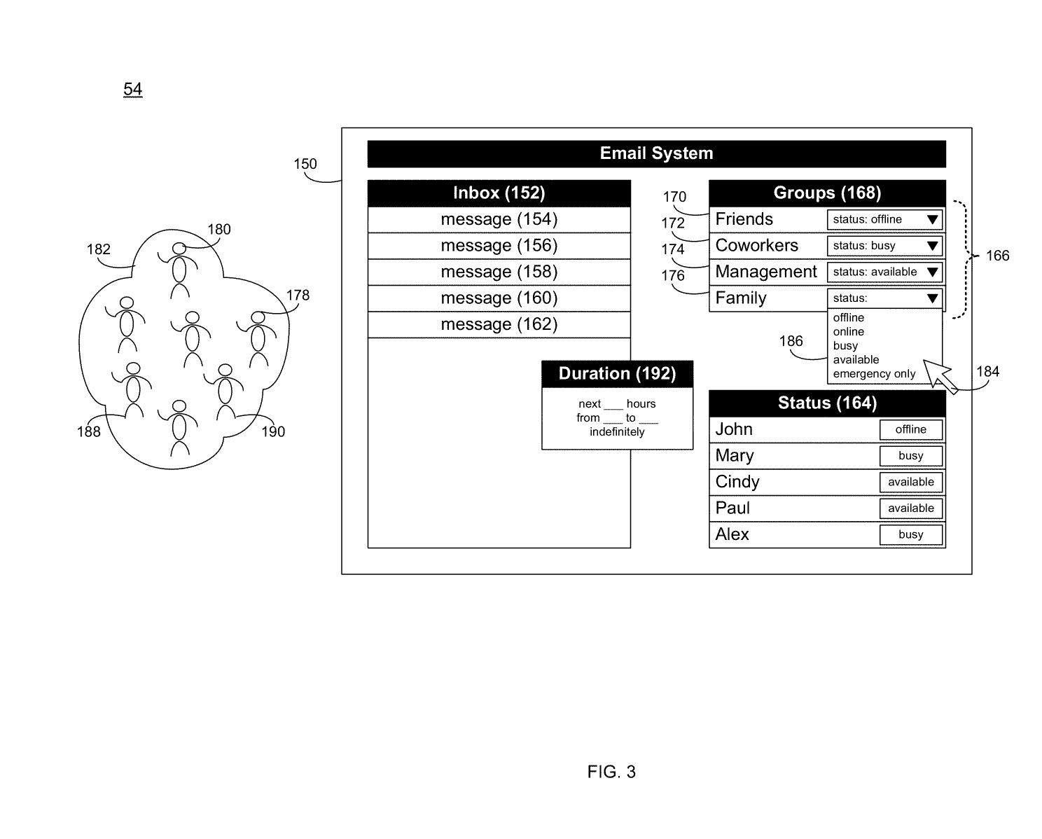

Referring also to FIG. 3, assume for illustrative purposes that user 38 is a member of (and utilizes) electronic communication platform 54, which in this example is a corporate email system. However and for the purpose of this disclosure, electronic communication system 54 may be any platform that enables communication between individuals, such as a social network (including SMS-based social networks), a messaging application, a chat platform, or an e-mail system.

Multi-status control process 10 may be e.g. a stand-alone program configured to work in conjunction with electronic communication platform 54, a plug-in applet configured for use within electronic communications platform 54, or a portion of electronic communication platform 54.

Electronic communication platform 54 may include graphical user interface 150 that may be configured to allow e.g. user 38 to navigate electronic communication platform 54. For example, graphical user interface 150 may include inbox window 152 that may be configured to display (in this example) one or more e-mail messages (e.g. e-mail messages 154, 156, 158, 160, 162).

Electronic communication platform 54 may be configured to allow the user (e.g. user 38) of such a platform to determine the status of various other users of electronic communication platform 54, wherein this status concerns e.g., the availability of those users to engage in an instant message type chat session. For example, graphical user interface 150 may include status window 164 that may be configured to display the status of various other users of electronic communication platform 54. For example, status window 164 may be configured to show the status of (in this example) five users, namely “John” identifying status of “off-line”; “Mary” identifying status of “busy”; “Cindy” identifying status of “available”; “Paul” identifying status of “available”; and “Alex” identifying status of “busy”. Accordingly and of these five individuals, two (namely “Cindy” and “Paul”) are available to engage in a chat session.

The particular individuals identified within status window 164 may vary depending upon the manner in which electronic communication platform 54 is configured. For example, electronic communication platform 54 may be configured to populate status window 164 with a list of the users of electronic communication platform 54 that (in this example) user 38 recently communicated with. Alternatively, electronic communication platform 54 may be configured so that (in this example) user 38 may manually add people to or remove people from status window 164. Alternatively still, electronic communication platform 54 may be configured to populate status window 164 with the users of electronic communication platform 54 that (in this example) user 38 identified as friends or placed within groups/circles of friends.

Through the use of multi-status control process 10, user 38 (in this example) may be able to define multiple statuses for themself, wherein a first status (with respect to user 38) may be presented to a first group of users of electronic communication platform 54, a second status (with respect to user 38) may be presented to a second group of users of electronic communication platform 54, and so on.

User 38 (in this example) may use multi-status control process 10 to define 100 plurality 166 of groups of users of electronic communication platform 54 (within groups window 168). Examples of such groups of users may include “friends” group 170, “coworkers” group 172, “management” group 174, and “family” group 176. Typically, at least one member of electronic communication platform 54 belongs to each of the plurality of groups (e.g., “friends” group 170, “coworkers” group 172, “management” group 174, and “family” group 176). While the above listing of groups is intended to be illustrative, it is not intended to be exhaustive. Accordingly, multi-status control process 10 may be configured to allow e.g., user 38 to select from a list of groups and/or may be configured to allow user 38 to define one or more custom groups.

Via multi-status control process 10, user 38 may add members to the groups they define (e.g., “friends” group 170, “coworkers” group 172, “management” group 174, and “family” group 176) by e.g., selecting the appropriate members (e.g., members 178, 180) from the plurality of members 182 of electronic communication platform 54.

Once a group (e.g., “friends” group 170, “coworkers” group 172, “management” group 174, and “family” group 176) has been defined 100, user 38 may use multi-status control process 10 to identify 102 a first user status (e.g., “offline”), which may be used by user 38 with respect to one of the above-mentioned groups (e.g., “friends” group 170 “coworkers” group 172, “management” group 174, and “family” group 176).

For example, assume that user 38 defined 100 “family” group 176 via multi-status control process 10. Once defined 100, user 38 may utilize onscreen pointer 184 (e.g., controllable by a mouse; not shown) to e.g., select dropdown menu 186, which may include a plurality of statuses (e.g., “offline”, “online”, “busy”, “available”, “emergency only”). Via onscreen pointer 184, user 38 may identify 102 the first user status (e.g., “offline”) and may associate 104 this first user status with the appropriate group (e.g., “family” group 176) of (e.g., chosen from) plurality of groups 166.

Therefore, if users 178, 180 were added to “friends” group 176 and user 38 defined their status for “friends” group 176 to be “offline”, in the event that users 178, 180 are using electronic communication platform 54 and review e.g., status window 164 to determine the status of user 38, the status of user 38 will be defined as “offline” for the members of “friends” group 176 (namely users 178, 180). Accordingly, such a configuration may be beneficial when e.g., user 38 is at work and unavailable to communicate/chat via electronic communication platform 54.

User 38 may use multi-status control process 10 to identify 106 a second user status (e.g., “busy”), which may be used by user 38 with respect to one of the above-mentioned groups (e.g., “friends” group 170 “coworkers” group 172, “management” group 174, and “family” group 176).

For example, assume that user 38 defined 100 “management” group 174 via multi-status control process 10. Once defined 100, user 38 may utilize onscreen pointer 184 (e.g., controllable by a mouse; not shown) to e.g., select a dropdown menu (similar to dropdown menu 186), which may include a plurality of statuses (e.g., “offline”, “online”, “busy”, “available”, “emergency only”). Via onscreen pointer 180, user 38 may identify 106 the second user status (e.g., “available”) and may associate 108 this second user status with the appropriate group (e.g., “management” group 174) chosen from plurality of groups 166.

Therefore, if users 188, 190 were added to “management” group 174 and user 38 defined their status for “management” group 174 to be “available”, in the event that users 188, 190 are using electronic communication platform 54 and review e.g., status window 164 to determine the status of user 38, the status of user 38 will be defined as “available” for the members of “management” group 174 (e.g., users 188, 190). Accordingly, such a configuration may be beneficial when e.g., user 38 is at work and always wants to be available to management via electronic communication platform 54.

Sometimes is may be desirable to define your availability to a group of people based upon the time of day/date. For example, user 38 may wish to make themselves available to friends only when they are not at work; may wish to make themselves available to coworkers only when they are at work; and may wish to make themselves available to family and management anytime.

Accordingly, when associating 104 the first user status (e.g., “offline”) with the first group (e.g., “family” group 176), multi-status control process 10 may associate 110 the first user status (e.g., “offline”) with the first group (e.g., “family” group 176) of (e.g., chosen from) plurality of groups 166 for a defined time interval. Examples of such a defined time interval may include but are not limited to: a defined quantity of time, and a defined window of time. For example, multi-status control process 10 may be configured to render duration window 192 (in response to user 38 identifying 102 the first user status) that may allow user 38 to define a time interval using e.g., onscreen pointer 184. Therefore and with respect to “family” group 176, user 38 may make themselves unavailable to chat between 9:00 a.m. and 5:00 p.m. (i.e., during the workday).

Further, when associating 108 the second user status (e.g., “available”) with the second group (e.g., “management” group 174), multi-status control process 10 may associate 112 the second user status (e.g., “available”) with the second group (e.g., “management” group 174) chosen from plurality of groups 166 for a defined time interval. Again, examples of such a defined time interval may include but are not limited to: a defined quantity of time, and a defined window of time. For example, multi-status control process 10 may be configured to render duration window 192 (in response to user 38 identifying 106 the second user status) that may allow user 38 to define a time interval using e.g., onscreen pointer 184. Therefore and with respect to “management” group 174, user 38 may make themselves continuously available to chat (i.e., regardless of whether it is during or outside of the workday).

General

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet.

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

What is claimed is:

1. A computer-implemented method comprising:
defining a plurality of groups for a user of an electronic communication platform, wherein at least one member of the electronic communication platform belongs to each of the plurality of groups;
identifying a first user status for the user of the electronic communication platform;
associating the first user status with a first group of the plurality of groups;
identifying a second user status for the user of the electronic communication platform; and
associating the second user status with a second group chosen from the plurality of groups.

2. The computer-implemented method of claim 1 wherein the first user status is different from the second user status.

3. The computer-implemented method of claim 1 wherein the plurality of groups includes one or more of: a coworkers group, a family group, and a friends group.

4. The computer-implemented method of claim 1 wherein associating the first user status with the first group includes associating the first user status with the first group chosen from the plurality of groups for a defined time interval.

5. The computer-implemented method of claim 4 wherein the defined time interval is chosen from the group consisting of: a defined quantity of time, and a defined window of time.

6. The computer-implemented method of claim 1 wherein associating the second user status with the second group includes associating the second user status with the second group chosen from the plurality of groups for a defined time interval.

7. The computer-implemented method of claim 6 wherein the defined time interval is chosen from the group consisting of: a defined quantity of time, and a defined window of time.

8. The computer-implemented method of claim 6 wherein the first group is chosen from the plurality of groups.

9. A computer program product residing on a computer readable medium having a plurality of instructions stored thereon which, when executed by a processor, cause the processor to perform operations comprising:
defining a plurality of groups for a user of an electronic communication platform, wherein at least one member of the electronic communication platform belongs to each of the plurality of groups;
identifying a first user status for the user of the electronic communication platform;
associating the first user status with a first group of the plurality of groups;
identifying a second user status for the user of the electronic communication platform; and
associating the second user status with a second group chosen from the plurality of groups.

10. The computer program product of claim 9 wherein the first user status is different from the second user status.

11. The computer program product of claim 9 wherein the plurality of groups includes one or more of: a coworkers group, a family group, and a friends group.

12. The computer program product of claim 9 wherein associating the first user status with the first group includes associating the first user status with the first group chosen from the plurality of groups for a defined time interval.

13. The computer program product of claim 12 wherein the defined time interval is chosen from the group consisting of: a defined quantity of time, and a defined window of time.

14. The computer program product of claim 9 wherein associating the second user status with the second group includes associating the second user status with the second group chosen from the plurality of groups for a defined time interval.

15. The computer program product of claim 14 wherein the defined time interval is chosen from the group consisting of: a defined quantity of time, and a defined window of time.

16. The computer program product of claim 9 wherein the first group is chosen from the plurality of groups.

17. A computing system including a processor and memory configured to perform operations comprising:
defining a plurality of groups for a user of an electronic communication platform, wherein at least one member of the electronic communication platform belongs to each of the plurality of groups;
identifying a first user status for the user of the electronic communication platform;
associating the first user status with a first group of the plurality of groups;
identifying a second user status for the user of the electronic communication platform; and
associating the second user status with a second group chosen from the plurality of groups.

18. The computing system of claim 17 wherein the first user status is different from the second user status.

19. The computing system of claim 17 wherein the plurality of groups includes one or more of: a coworkers group, a family group, and a friends group.

20. The computing system of claim 17 wherein associating the first user status with the first group includes associating the first user status with the first group chosen from the plurality of groups for a defined time interval.

21. The computing system of claim 20 wherein the defined time interval is chosen from the group consisting of: a defined quantity of time, and a defined window of time.

22. The computing system of claim 17 wherein associating the second user status with the second group includes associating the second user status with the second group chosen from the plurality of groups for a defined time interval.

23. The computing system of claim 22 wherein the defined time interval is chosen from the group consisting of: a defined quantity of time, and a defined window of time.

24. The computing system of claim 17 wherein the first group is chosen from the plurality of groups.
